(19) United States
(12) Patent Application Publication
(10) Pub. No.: US 2008/0062121 A1
(43) Pub. Date: Mar. 13, 2008

(54) SHUTTLE CONTROL SYSTEM FOR CONTROLLING KVM SWITCH AND METHOD THEREOF

(75) Inventors: Shih-Yuan Huang, Shijr City (TW); Chih-Tao Hsieh, Shijr City (TW)

Correspondence Address: MADSON & AUSTIN, 15 WEST SOUTH TEMPLE, SUITE 900, SALT LAKE CITY, UT, 84101, US

(73) Assignee: Aten Interational Co., Ltd., Shijr City (TW)

(21) Appl. No.: 11/530,351

(22) Filed: Sep. 8, 2006

(51) Int. Cl. G09G 5/00

(52) U.S. Cl. 345/156

(57) ABSTRACT

A shuttle control system to generate control signals to operate a control menu or an on-screen display menu for controlling a KVM switch. The shuttle control system includes a shuttle control module and a KVM control module. The shuttle control module generates control signals. The KVM control module receives the control signals from the shuttle control module to control the KVM switch. The KVM switch further includes a user interface to show the control menu. The control signals may comprise a left signal, a right signal and an enter signal. The shuttle control module generates the control signals by a user to operate the control menu or the on-screen display menu for switching between the plurality of computers.

### FIELD OF THE INVENTION

The present invention generally relates to shuttle control system for controlling a KVM switch, and more particularly to a shuttle control system to generate control signals to operate a control menu or an on-screen display menu for controlling a KVM switch and method thereof.

### BACKGROUND OF THE INVENTION

Switching to different computers at a console by a user is an essential and frequent operation to a KVM switch and it is basically what the KVM switch appears to be. Generally, there are two ways to switch the KVM switch between different computers. One is to invoke the on-screen display menu on a display of the console and to change the access from the computer which is currently being operated, to another computer. The other is to push the select buttons on the front panel of the KVM switch to directly switch to the corresponding computers.

Please refer to FIG. 1, which shows a three-dimensional drawing of a KVM switch providing select buttons on the front panel for switching between different computers according to prior art. The KVM switch 10 is an 8-port KVM switch, which is capable of coupling eight computers for the console. Therefore, eight select buttons for the respective computers are installed in the front panel of the KVM switch 10. Moreover, there are eight or more indicating LEDs disposed on the front panel to show respective control status, data transmission status or other functions for the respective computers. However, these indicating LEDs and the select buttons occupy quite large area of the front panel and substantial space inside the KVM switch 10. In the age of simplification and microminiaturization, such drawback is unbearable to a user or a consumer.

Furthermore, computer connections of a modern KVM switch may up to a dozen or even more. With extension ability of daisy chaining or cascading interconnections between a plurality of KVM switches, the computer connections may up to thousands. Therefore, according to the prior art, corresponding number of select buttons for all the computers coupled thereto may be installed on the front panel of each KVM switches. As a result, the front panel becomes crowed after installing the select buttons, especially for KVM switches capable of managing over 8 computers. Accordingly, invoking the on-screen display menu on the display becomes the only choice.

Consequently, there is a need to develop a shuttle control system for controlling a KVM switch.

### SUMMARY OF THE INVENTION

To solve the foregoing drawbacks in the prior art, it is an objective of the present invention is to provide a shuttle control system to generate control signals to operate a control menu or an on-screen display menu for controlling a keyboard-video-mouse (KVM) switch and method thereof. The shuttle control system for replacing all the select buttons and the indicating LEDs can be a solution of aforesaid problem. Furthermore, the shuttle control system may provide basic or more advanced functions for controlling the KVM switch.

The shuttle control system for controlling a KVM switch includes a shuttle control module and a keyboard-video-mouse (KVM) control module. The shuttle control module generates control signals. The KVM control module receives the control signals from the shuttle control module to control the KVM switch. The KVM switch further includes a user interface to show the control menu. Alternatively, the KVM switch includes an on-screen display module, generating an on-screen display menu. Correspondingly, the KVM switch may show the aforesaid control menu on the user interface or show the on-screen display menu, which is previously shown on a display on the user interface. The shuttle control module generates the control signals to operate the control menu or the on-screen display menu for switching between the plurality of computers. The control signals may comprise a left signal, a right signal and an enter signal.

The shuttle control module may be disposed in a hand-held remote controller. Accordingly, the hand-held remote controller includes a wireless transmitter and the KVM switch further includes a wireless receiver. The hand-held remote controller transmits the control signals generated by the shuttle control module via the wireless transmitter and the KVM control module receives the control signals via the wireless receiver. Therefore, controlling the KVM switch by the shuttle control system wirelessly can be achieved.

The present invention further provides a method of controlling a KVM switch by a shuttle control system. The method includes steps as described below:

generating control signals with the shuttle control system; and

controlling the KVM switch according to the control signals.

Before the step of generating the control signals, the present invention further includes a step of invoking a control menu on a user interface or an on-screen display menu on a display.

Accordingly, the shuttle control system for controlling a KVM switch according to the present invention can generate control signals to operate the control menu or the on-screen display menu for switching between a plurality of computers coupled with the KVM switch. Moreover, it is a great benefit for simplifying the crowded front panel of the KVM switch while reducing select control button, indicating LEDs and their corresponding circuits inside.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a three-dimensional drawing of a conventional KVM switch, which needs respective select buttons for switching coupled computers among respective ports;

FIG. 2 shows a three-dimensional drawing of a KVM switch according to the present invention, which is controlled by a shuttle control system;

FIG. 3 illustrates a functional block diagram of a shuttle control system embedded in a KVM switch according to a first embodiment of the present invention;

FIG. 4 illustrates a functional block diagram of a shuttle control system embedded in a hand-held remote controller according to a second embodiment of the present invention;

FIG. 5 illustrates a functional block diagram of a shuttle control system, which is accomplished as a in-line shuttle controller, according to a third embodiment of the present invention; and

FIG. 6 shows a flow chart of the method of controlling a keyboard-video-mouse switch by a shuttle control system according to the present invention.

### DETAILED DESCRIPTION OF THE PREFERRED EMBODIMENTS

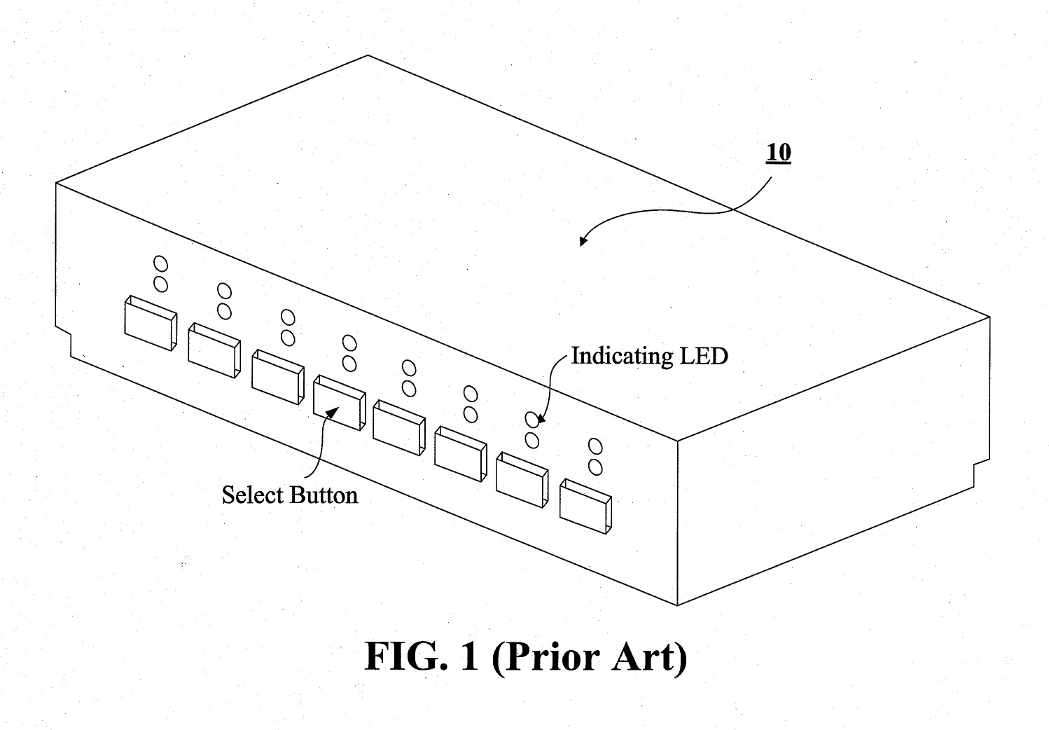

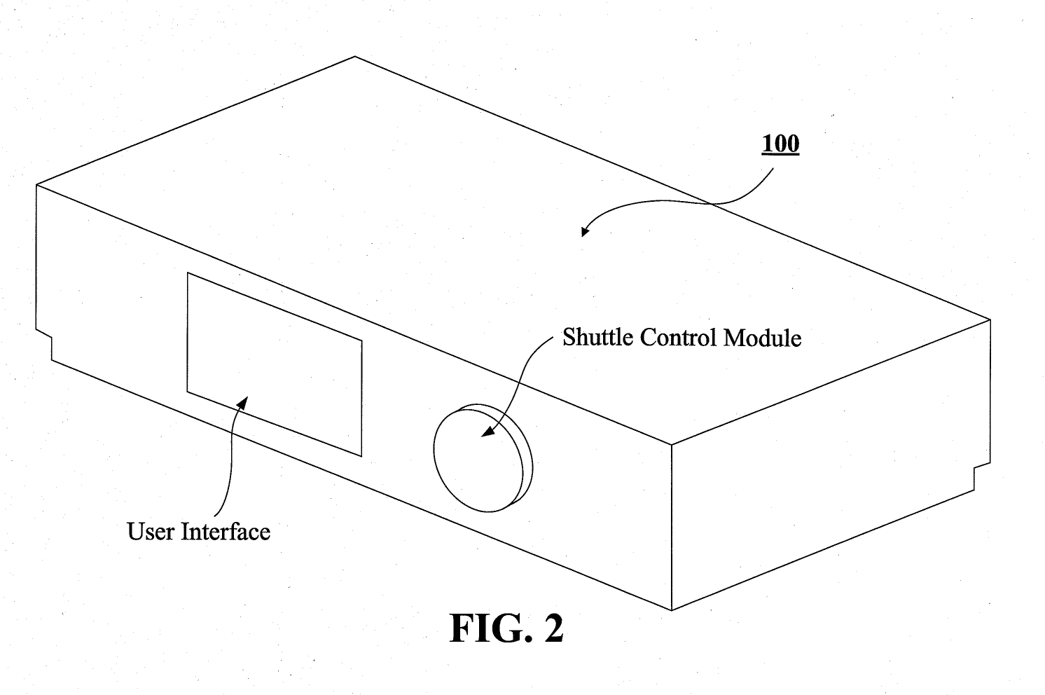

Please refer to FIG. 2, which shows a three-dimensional drawing of a KVM switch according to the present invention, which is controlled by a shuttle control system. The KVM switch 100 can be an N-port KVM switch, which is capable of coupling N computers for the console. The select buttons and indicating LEDs on the front panel of the KVM switch 10 shown in FIG. 1 can be physically removed and replaced by a shuttle control module of the KVM switch 100 shown in FIG. 2. Furthermore, a user interface for showing a control menu, similar to an on-screen display menu, may be installed on the KVM switch 100. The user interface may be a small LCD display. The user of the KVM switch 100 rotates or pushes the shuttle control module to generate control signals. Therefore, the control menu or the on-screen display menu are operated by the control signals generated by the shuttle control module. The benefit of the present invention is that the user of the KVM switch 100 can switch to different computers even the computers coupled thereto is up to thousand by using only the shuttle control module to operate the control menu or the on-screen display menu.

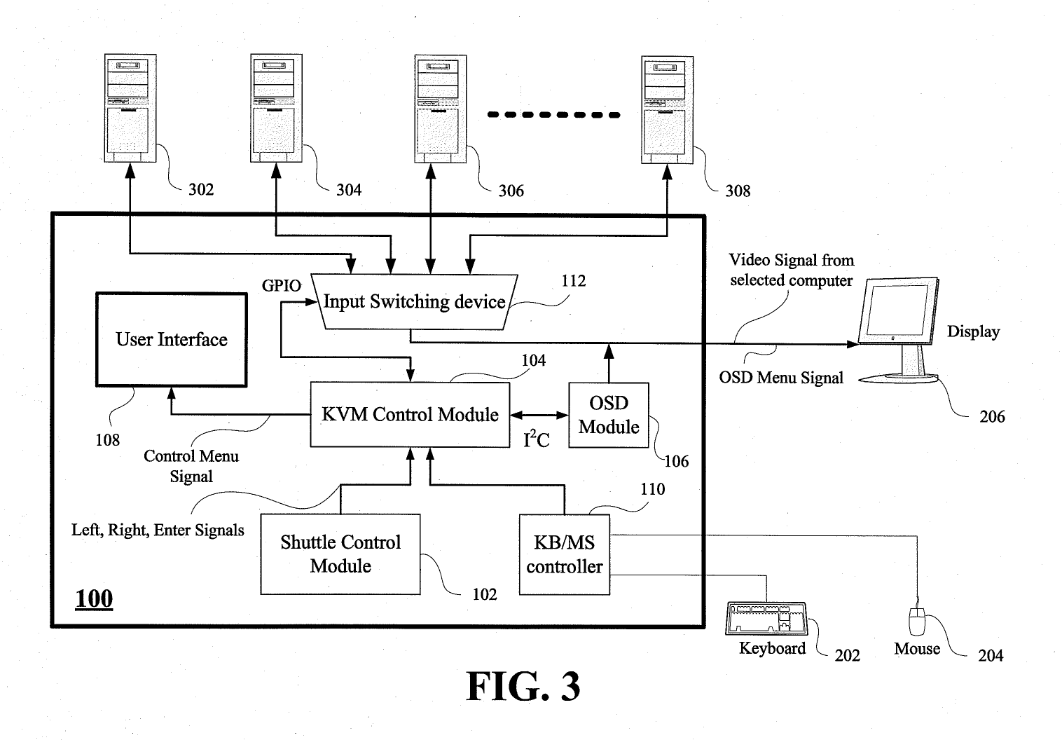

Please refer to FIG. 3, which illustrates a functional block diagram of a shuttle control system embedded in a KVM switch 100 according to a first embodiment of the present invention. The shuttle control system includes a shuttle control module 102 and a keyboard-video-mouse control module 104. The KVM switch 100 may further include an on-screen display (OSD) module 106, a user interface 108, a keyboard/mouse (KB/MS) controller 110 and an input switching device 112. The KVM switch 100 is coupled with a plurality of computers 302, 304, 306 and 308 via the input switching device 112 to receive video signals and send keyboard/mouse signals from/to the computers 302, 304, 306 and 308 respectively. A display 206 is coupled to the KVM switch 100. The display 206 receives the video signals from one of the computers 302, 304, 306 and 308, and may receive the on screen display (OSD) menu signal generated by the OSD module 106 when the OSD menu is invoked by the user. Meanwhile, a keyboard 202 and a mouse 204 are coupled to the KVM switch 100 via the KB/MS controller 110.

The user interface 108 is employed to show a control menu, similar to the aforesaid OSD menu, which is previously shown on the display 206. When the user rotates or pushes the shuttle control module 102, the shuttle control module 102 generates the control signals accordingly to operate the control menu shown on the user interface 108. Meanwhile, the keyboard-video-mouse control module 104 receives the control signals to control corresponding operations of the KVM switch 100. The control signals generated by the shuttle control module 102 may include a left signal, a right signal and an enter signal.

Just like operating the control menu or the OSD menu by the keyboard 202 or the mouse 204, the user may rotate or push the shuttle control module 102 to input the left signal, the right signal or the enter signal to operate the control menu or the OSD menu. In the case when the KVM switch 100 does not include a user interface 108, the user still can operate the OSD menu shown on the display 206 by using the shuttle control module 102. The KVM switch 100 can be designed to show the control menu or the OSD menu on the user interface 108, the display 206 or both according to what the users demand. Meanwhile, with double control mode—by the keyboard 202 and the mouse 204 and by the shuttle control module 102, the user can have more power and flexibility to operate to control the KVM switch 100. Especially, the basic function of switching between the computers 302, 304, 306 and 308 coupled thereto.

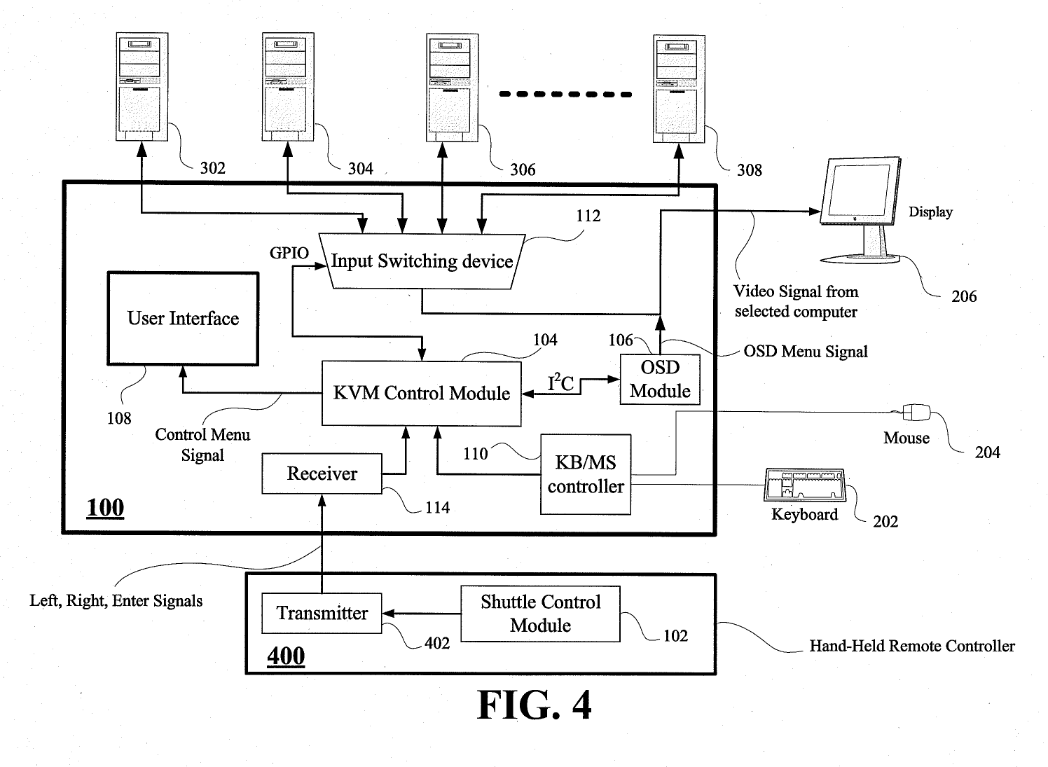

Please refer to FIG. 4, which illustrates a functional block diagram of a shuttle control system embedded in a hand-held remote controller 400 according to a second embodiment of the present invention. For achieving wireless remote control, the hand-held remote controller 400 further includes a wireless transmitter 402 coupled with the shuttle control module 102. Meanwhile the KVM switch 100 further includes a wireless receiver 114 coupled with the keyboard-video-mouse control module 104. The user rotates or pushes the shuttle control module 102 embedded in the hand-held remote controller 400 to generate the aforesaid control signals. The hand-held remote controller 400 transmits the control signals via the wireless transmitter 402 and the keyboard-video-mouse control module 104 receives the control signals via the wireless receiver 114.

Alternatively, the user interface 108 can be considered to be embedded in the hand-held remote controller 400 for a better remote control to provide useful information, such as the aforesaid control menu, when the user is far away from the KVM switch 100 and the display 206. The wireless transmitter 402 may have to be replaced by a first wireless transceiver and the wireless receiver 114 may have to be replaced by a second wireless transceiver. Accordingly, when the user rotates or pushes the shuttle control module 102, the hand-held remote controller 400 transmits the control signals via the first wireless transceiver and the keyboard-video-mouse control module 104 receives the control signals via the second wireless transceiver. Furthermore, the keyboard-video-mouse control module 104 transmits respond information via the second wireless transceiver and the hand-held remote controller 400 receives the respond information via the first wireless transceiver to be shown the control menu on the user interface 108. Specifically, the specification of the wireless transmitter, the wireless receiver, and the first, second wireless transceivers is not restricted to specified wireless transmission standard.

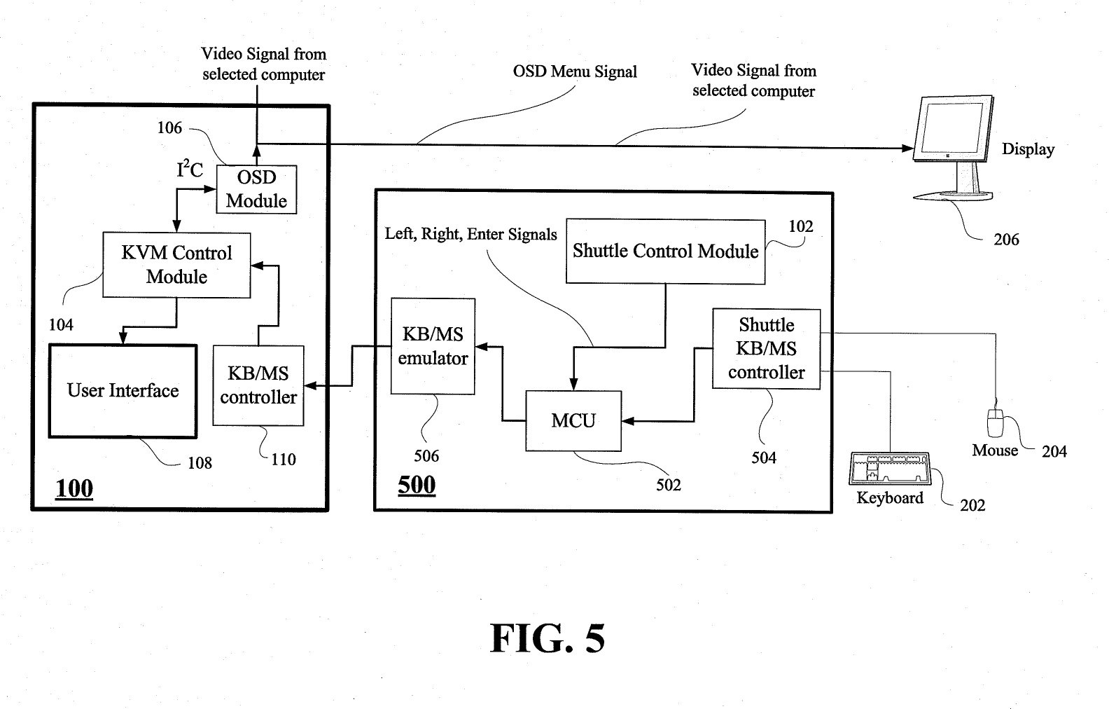

Please refer to FIG. 5. It illustrates a functional block diagram of a shuttle control system, which is accomplished as an in-line shuttle controller 500, coupling to a KVM switch 100 and a set of keyboard 202 and mouse 204 respectively according to a third embodiment of the present invention. Basically, the in-line shuttle controller 500 can be operated as a jog knob connected between the KVM switch 100 and the set of keyboard 202 and mouse 204 for providing a different operation way from the one of the keyboard 202 and mouse 204 controlling the KVM switch 100. The in-line shuttle controller 500 includes a shuttle control module 102, a micro control unit (MCU) 502, a shuttle keyboard/mouse (KB/MS) controller 504 and a keyboard/mouse (KB/MS) emulator 506. The shuttle controller 500 is coupled with the keyboard 202 and mouse 204 via the shuttle KB/MS controller 504 for accepting keyboard/mouse signals from the keyboard 202 and the mouse 204. The shuttle controller 500 is coupled to the KB/MS controller 110 of the KVM switch 100 via the KB/MS emulator 506, and the communication thereof may be established with a physical transmission line or a wireless link.

The user can rotate or push the shuttle control module 102 to generate control signals, i.e. the left signal, the right signal or the enter signal similarly as he uses the keyboard 202 and the mouse 204. The MCU 502 is coupled with the shuttle KB/MS controller 504 and the shuttle control module 102 respectively. Moreover, the MCU 502 transforms the keyboard/mouse signals from the keyboard 202, the mouse 204 and the control signals from the shuttle control module 102 into control instructions. Then, the MCU 502 transmits the control instructions to the KB/MS emulator 506. The KB/MS emulator 506 generates emulated keyboard/mouse signals according to the control instructions for controlling the KVM switch 100.

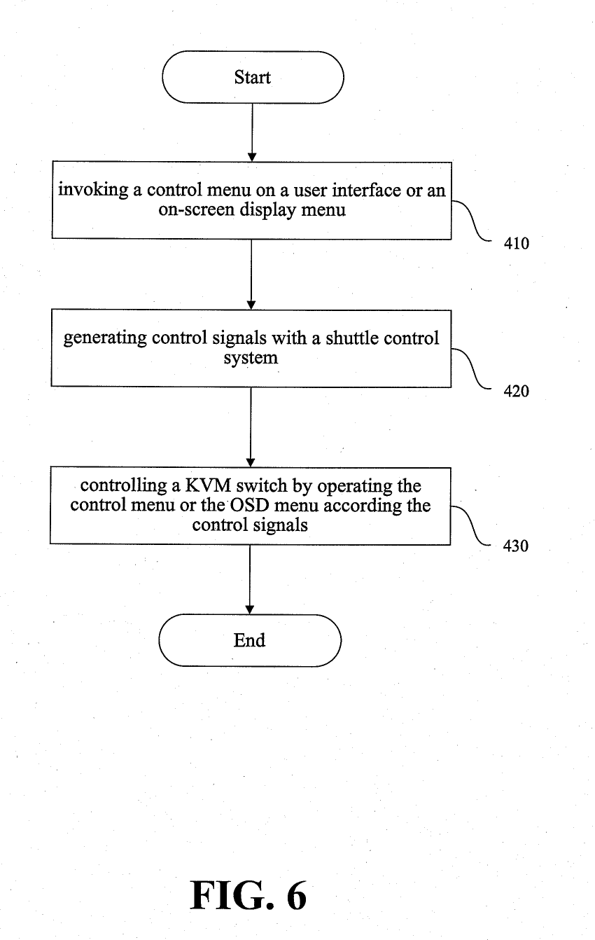

Please refer to FIG. 6, which shows a flow chart of the method of controlling a keyboard-video-mouse switch by a shuttle control system according to the present invention. For accomplishing the objective of the present invention, the method of the present invention includes the steps below:

In step 420, generating control signals with the shuttle control system; and

In step 430, controlling the KVM switch by operating a control menu or an OSD menu according the control signals. Alternatively, before step 420, there may further be a step 410 which invoking the control menu on a user interface or the on-screen display menu on a display. The control menu and the on-screen display may be invoked by the keyboard, mouse as in convention technique, or by the shuttle control system according to the present invention.

According to the shuttle control system and method of the present invention, generating control signals to operate a control menu or an on-screen display menu to switch between a plurality of computers coupled with the KVM switch by a shuttle control module can be achieved. Moreover, a great benefit for simplifying the crowded front panel of the KVM switch while reducing select control buttons, indicating LEDs and their corresponding circuits inside can be realized to overcome the drawbacks of the prior arts.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A shuttle control system for controlling a KVM switch coupled with a plurality of computers, the system comprising:
a shuttle control module, generating control signals; and
a keyboard-video-mouse control module, receiving the control signals from the shuttle control module to control the KVM switch.

2. The shuttle control system of claim 1, wherein the control signals are capable of making the KVM switch switching between the plurality of computers.

3. The shuttle control system of claim 1, further comprising an on-screen display module, generating an on-screen display menu on a display, and the on-screen display menu is operable by the control signals.

4. The shuttle control system of claim 3, wherein the control signals comprises a left signal, a right signal and an enter signal.

5. The shuttle control system of claim 1, further comprising a user interface to show a control menu and the control menu is operable by the control signals.

6. The shuttle control system of claim 5, wherein the control signals comprises a left signal, a right signal and an enter signal.

7. The shuttle control system of claim 1, wherein the shuttle control module is disposed in a remote controller.

8. The shuttle control system of claim 7, wherein the remote controller further comprises a wireless transmitter coupled with the shuttle control module, and the KVM switch further comprises a wireless receiver coupled with the keyboard-video-mouse control module such that the remote controller transmits the control signals generated by the shuttle control module via the wireless transmitter and the keyboard-video-mouse control module receives the control signals via the wireless receiver.

9. The shuttle control system of claim 5, wherein the user interface and the shuttle control module are both disposed on a remote controller.

10. The shuttle control system of claim 9, wherein the remote controller further comprises a first wireless transceiver coupled with the shuttle control module and the KVM switch further comprises a second wireless transceiver coupled with the keyboard-video-mouse control module such that the remote controller transmits the control signals generated by the shuttle control module via the first wireless transceiver, and the keyboard-video-mouse control module receives the control signals via the second wireless transceiver; the keyboard-video-mouse control module transmits respond information via the second wireless transceiver, and the remote controller receives the respond information via the first wireless transceiver to be shown on the control menu.

11. A shuttle control system for controlling a KVM switch, the system comprising:
a shuttle keyboard/mouse controller, coupling with a keyboard and a mouse, for accepting keyboard/mouse signals from the keyboard and the mouse;
a shuttle control module, generating control signals;
a micro control unit, coupling with the shuttle keyboard/mouse controller and the shuttle control module, for transforming the keyboard/mouse signals and the control signals into control instructions; and
a keyboard/mouse emulator, coupling with the micro control unit, for generating emulated keyboard/mouse signals according to the control instructions for controlling the KVM switch.

12. The shuttle control system of claim 11, wherein the control signals are capable of making the KVM switch switching between the plurality of computers.

13. The shuttle control system of claim 11, wherein shuttle control module generates the control signals to operate an on-screen display menu of the KVM switch.

14. The shuttle control system of claim 13, wherein the control signals comprises a left signal, a right signal and an enter signal.

15. A method of controlling a KVM switch coupled with a plurality of computers by a shuttle control system, the method comprising steps of:
generating control signals with the shuttle control system; and
controlling the KVM switch according to the control signals.

16. The method of claim 15, wherein the controlling step comprises making the KVM switch switching between the plurality of computers according to the control signals.

17. The method of claim 15, further comprising a step of invoking an on-screen display menu on a display before the step of generating the control signals.

18. The method of claim 17, wherein the control signals are capable of operating the on-screen display menu on the display.

19. The method of claim 16, further comprising a step of invoking a control menu shown on a user interface before the step of generating the control signals.

20. The method of claim 19, wherein the control signals are capable of operating the control menu shown on the user interface.
